(19) United States
(12) Patent Application Publication
(10) Pub. No.: US 2014/0301587 A1
(43) Pub. Date: Oct. 9, 2014

(54) SLIM ENCLOSURE SPEAKER WITH SIDE ACOUSTIC EMISSION STRUCTURE

(71) Applicant: EM-TECH Co., Ltd., Busan (KR)

(72) Inventors: Yong Ju Ji, Gimhae-si (KR); Sung Chul Jung, Changwon-si (KR)

(21) Appl. No.: 14/230,567

(22) Filed: Mar. 31, 2014

(30) Foreign Application Priority Data
Apr. 3, 2013 (KR) 10-2013-0036162

(51) Int. Cl. H04R 1/02

(52) U.S. Cl. CPC H04R 1/021
USPC 381/332

(57) ABSTRACT

A slim enclosure speaker is provided with a side acoustic emission structure, which can make the enclosure speaker slimmer by maximizing a sound-emitting hole in the same size, while improving SPL characteristics. The slim enclosure speaker with the side acoustic emission structure includes: a microspeaker; a lower case enclosing the lower side of the microspeaker and defining a resonance space; an upper case having a fixing surface to which top edges of the microspeaker are fixed, defining the resonance space together with the lower case, and having a hole inside the fixing surface; a cover coupled onto the upper case and covering the hole; and an acoustic passage defined by one side of the upper case and the cover, wherein the fixing surface is insert injection-molded using a steel.

### PRIORITY CLAIM

The present application claims priority to Korean Patent Application No. 10-2013-0036162 filed on Apr. 3, 2013, the content of said application incorporated herein by reference in its entirety.

### TECHNICAL FIELD

The present invention relates to a slim enclosure speaker with a side acoustic emission structure.

### BACKGROUND

FIG. 1 is an exploded perspective view showing a conventional slim enclosure speaker with a side acoustic emission structure, FIG. 2 is a perspective view showing the conventional slim enclosure speaker with the side acoustic emission structure, and FIG. 3 is a sectional view taken along line A-A′ of FIG. 2.

The conventional slim enclosure speaker with the side acoustic emission structure includes a microspeaker 10, a lower case 20, an upper case 30, and a cover 40 coupled onto the upper case 30. A thin steel portion 26, which is made of an SUS material, is injection-molded at the central portion of the lower case 20, and an injection-molded portion includes a bottom surface 24, which is thicker than the steel portion 26 to form a stepped portion, and sidewalls 22 enclosing the side surfaces.

The upper case 30 is coupled onto the lower case 20 and includes sidewalls 32 coupled onto the sidewalls 22 of the lower case 20, a fixing surface 34 to which a microspeaker 10 is fixed, and a top surface having a seating portion 36 for coupling to the cover 40. At one side of the upper case 30, the sidewall 32 and the seating portion 36 are partially removed, thus forming a slant surface 38 and a level surface 39, the slant surface being connected to the fixing surface 34, the level surface 39 being disposed outside the slant surface 38. When the cover 40 is coupled onto the upper case 30, a space between the cover 40 and the slant surface 30 and the level surface 39 becomes an acoustic passage 50 for emitting sounds.

Typically, the magnitude of the sound is expressed in dB and represented as a sound pressure level (SPL) or efficiency in a speaker system. This means ‘the average magnitude of the sound that can be heard 1 m from the speaker, when an output of 1 w (2.83v) is transferred from an amplifier to the speaker’. Therefore, the greater the sound pressure is, the greater the reproduced sound is with the same output of the amplifier.

In the case of the conventional slim enclosure speaker with the side acoustic emission structure as shown in FIGS. 1 to 3, as a line for emitting sounds gets narrower, a sound pressure in low frequencies becomes lower. In low frequencies having a relatively large amplitude, an amount of pushing the air increases. As the air passes through such a narrow line, its resistivity increases, which degrades low sound characteristics. If an effective area of a sound-emitting hole is reduced to make the enclosure speaker slimmer, the SPL at low sounds is reduced. Accordingly, there are still needs for a technology of making the enclosure speaker slimmer while maximizing the sound-emitting hole in the same size.

### SUMMARY

An object of the present invention is to provide a slim enclosure speaker with a side acoustic emission structure, which can make the enclosure speaker slimmer by maximizing a sound-emitting hole in the same size, while improving SPL characteristics.

According to an aspect of the present invention, there is provided a slim enclosure speaker with a side acoustic emission structure, the slim enclosure speaker including: a microspeaker; a lower case enclosing the lower side of the microspeaker and defining a resonance space; an upper case having a fixing surface to which top edges of the microspeaker are fixed, defining the resonance space together with the lower case, and having a hole inside the fixing surface; a cover coupled onto the upper case and covering the hole; and an acoustic passage defined by one side of the upper case and the cover, wherein the fixing surface is insert injection-molded using a steel.

In some embodiments, the central portion of the lower case and the central portion of the cover are composed of insert injection-molded steel portions, respectively, which are thinner than injection-molded portions to form stepped portions.

In some embodiments, a resonance space is defined between the steel portion of the lower case and the microspeaker.

In some embodiments, the microspeaker is attached to the fixing surface of the upper case by means of a bond.

In some embodiments, coupling of the upper case and the lower case and coupling of the upper case and the cover are realized by means of bond attachment or ultrasonic welding.

In some embodiments, the slim enclosure speaker with the side acoustic emission structure is manufactured by attaching the microspeaker to the fixing surface of the upper case by means of a bond, coupling the upper case and the lower case by means of ultrasonic welding, and attaching the cover to the upper case by means of a bond.

The slim enclosure speaker with the side acoustic emission structure according to the present invention can maximize the size of the acoustic passage, by replacing the microspeaker-fixing portion of the enclosure case by a thin but rigid steel.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 is an exploded perspective view showing a conventional slim enclosure speaker with a side acoustic emission structure;

FIG. 2 is a perspective view showing the conventional slim enclosure speaker with the side acoustic emission structure;

FIG. 3 is a sectional view taken along line A-A′ of FIG. 2;

FIG. 4 is an exploded perspective view showing a slim enclosure speaker with a side acoustic emission structure according to one embodiment of the present invention;

FIG. 5 is a perspective view showing the slim enclosure speaker with the side acoustic emission structure according to one embodiment of the present invention;

FIG. 6 is a sectional view taken along line B-B′ of FIG. 5; and

FIG. 7 is a schematic view showing a method of assembling a slim enclosure speaker with a side acoustic emission structure according to one embodiment of the present invention.

### DETAILED DESCRIPTION

Hereinafter, a slim enclosure speaker with a side acoustic emission structure according to the present invention will be described in more detail with reference to the accompanying drawings.

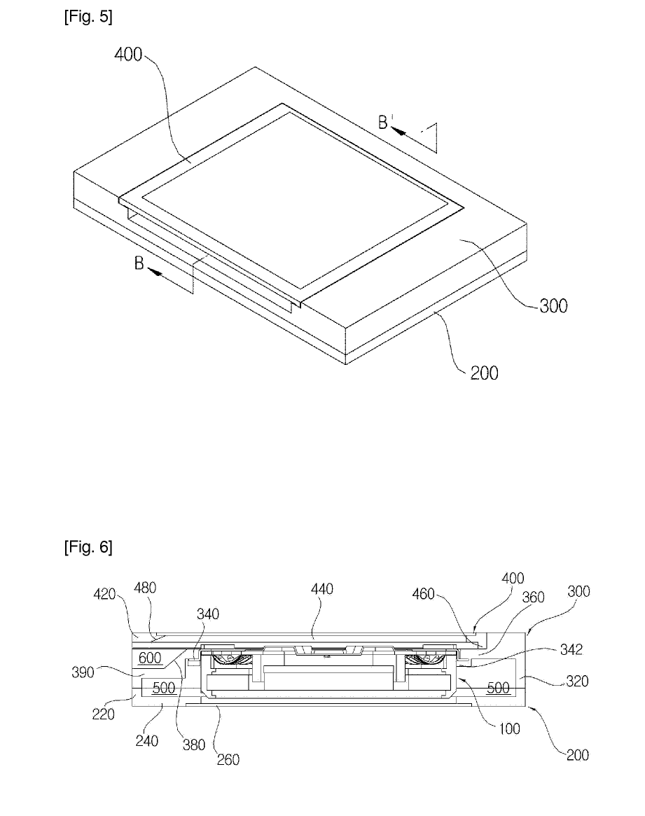

FIG. 4 is an exploded perspective view showing a slim enclosure speaker with a side acoustic emission structure according to one embodiment of the present invention, FIG. 5 is a perspective view showing the slim enclosure speaker with the side acoustic emission structure according to one embodiment of the present invention, and FIG. 6 is a sectional view taken along line B-B′ of FIG. 5.

The slim enclosure speaker with the side acoustic emission structure according to one embodiment of the present invention includes a microspeaker 100, a lower case 200, an upper case 300, and a cover 400 coupled onto the upper case 300. A recessed portion is provided at one side upper portion of the upper case 300 to define an acoustic passage 600 when the upper case 300 is coupled to the cover 400. This recessed portion is a slant surface 380 and a level surface 390 which will be discussed later.

The lower case 200 includes a bottom surface 240 and sidewalls 220, which are composed of an injection-molded product, and a steel portion 260 made of a thin SUS material which is insert injection-molded at the center of the bottom surface 240 during the injection molding of the lower case 200.

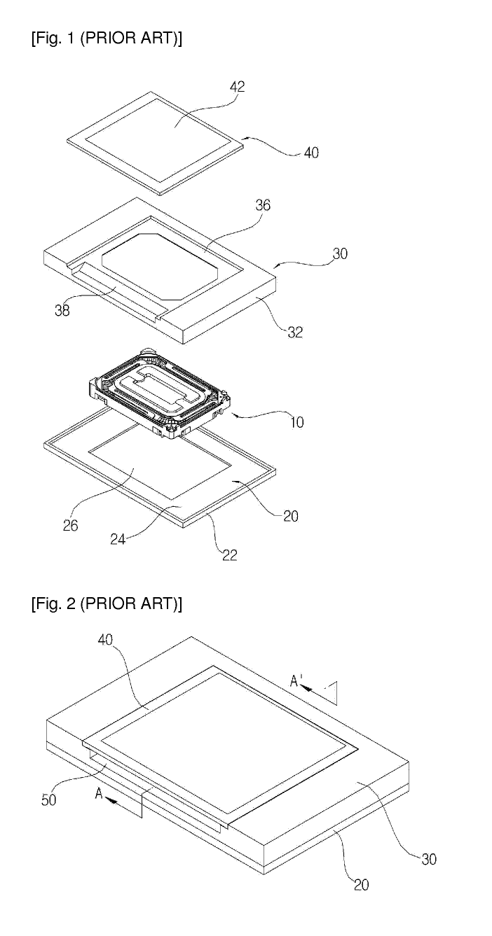

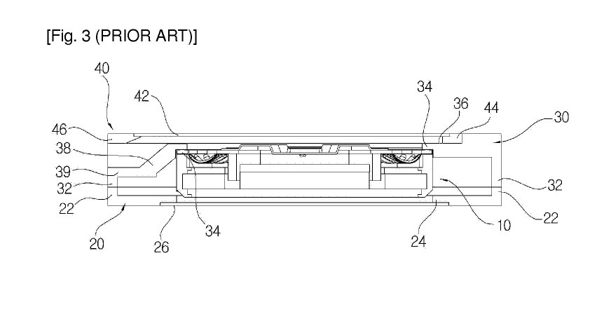

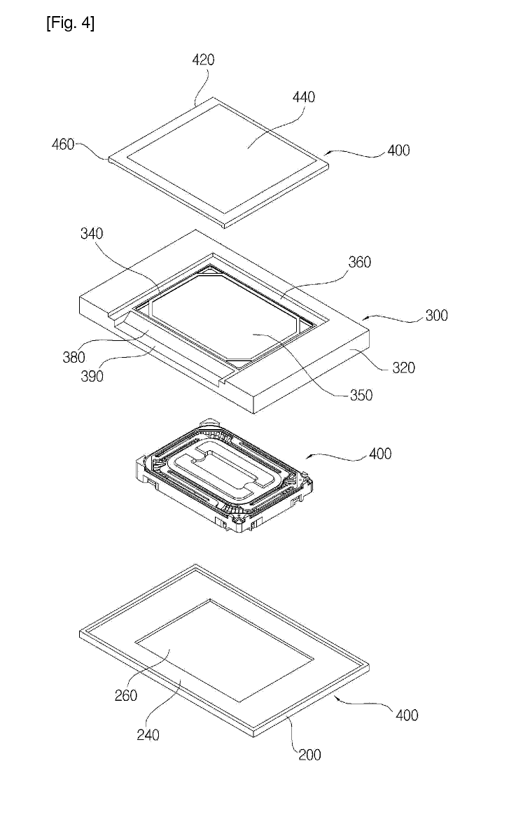

The upper case 300 is coupled onto the lower case 200 to define a resonance space 500, and includes sidewalls 320 coupled onto the sidewalls 220 of the lower case 200, a fixing surface 340 to which the microspeaker 100 is fixed, and a top surface having a seating portion 360 for coupling to the cover 400. A hole 350 is formed inside the fixing surface 340, and the cover 400 covers the hole 350 formed inside the fixing surface 340, the slant surface 380, and the level surface 390. The upper case 300 is composed of an injection-molded product except for the fixing surface 340, and the fixing surface 340 is made of an SUS steel material, so can be thinner than that of the prior art and can have sufficient rigidity. For example, the fixing surface 34 of the upper case 30 as shown in FIGS. 1 to 3 is composed of an injection-molded product, like the other portions, and thus has a thickness of about 0.4 T (mil). Even with this thickness, the fixing surface 340 may not be sufficiently rigid to avoid fracture. On the contrary, in the embodiment of the present invention, the fixing surface 340, which is insert injection-molded using a steel, can have sufficient rigidity even with a thickness of 0.1 T.

The upper side of the upper case 300 includes an injection-molding fixing portion 342 for covering the fixing surface 340 from the top and bottom during the insert injection-molding. In addition, the upper side of the upper case 300 includes the seating portion 360, so that the cover 400 for covering the hole 350, the slant surface 380 and the level surface 390 can be seated thereon. The hole 350 and the cover 400 are generally rectangular, while the seating portion 360 is formed in a [symbol] (rectangle with one side open)’ shape to support three edges of the cover 400, except the acoustic passage 600, to avoid crossing the slant surface 380 and the level surface 390 which are provided to define the acoustic passage 600, as described earlier. Three edges of the seating portion 360 are two opposite edges and one edge perpendicular to the two opposite edges. They are spaced apart from the edges of the upper case 300, respectively, but the two opposite edges are extended at one end to the end of the upper case 300. The reason for this is because the cover 400 should cover the slant surface 380 and the level surface 390 as well as the hole 350, and because the acoustic passage 600 is defined by the cover 400 and the recessed portion including the slant surface 380 and the level surface 390. That is, the two opposite edges of the seating portion 360 are extended to one side of the slant surface 380 and the level surface 390, respectively.

The slant surface 380 and the level surface 390 are provided at one side of the upper case 300, the slant surface being downwardly recessed, the level surface being disposed outside the slant surface. When the cover 400 is coupled onto the upper case 300, a space between the cover 400 and the slant surface 380 and the level surface 390 becomes the acoustic passage 600 for emitting sounds.

As a result, when the size of the whole enclosure speaker is the same, it is assumed that the greater the distance between the cover 400 and the fixing surface 340 is, the larger the acoustic passage 600 is. The fixing surface 340 as disclosed herein is made of an insert injection-molded steel, so can be thin and rigid.

Also, the central portion of the cover 400 is composed of a steel portion 440, while the remaining portions are composed of an injection-molded portion 420. Further, since the fixing surface 340 is made thinner using a steel, a seating portion 460 which is brought into contact with the seating portion 360 can be made higher than the other injection-molded portion 420, thereby increasing the size of the acoustic passage 600 in the same size of the whole enclosure speaker.

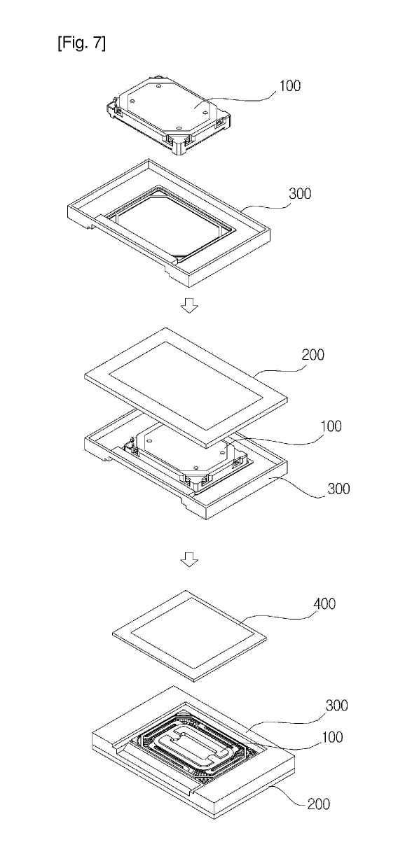

FIG. 7 is a schematic view showing a method of assembling a slim enclosure speaker with a side acoustic emission structure according to one embodiment of the present invention. First, the microspeaker 100 is attached to the bottom surface of the fixing surface 340 (see FIG. 4) of the upper case 300 by means of a bond. Then, the upper case 300 and the lower case 200 are coupled to each other. The upper case 300 and the lower case 200 are coupled by means of bond attachment or ultrasonic welding. Thereafter, the cover 400 is coupled to the seating portion 360 (see FIG. 4) of the upper case 300. Coupling of the cover 400 is realized by means of a bond.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A slim enclosure speaker with a side acoustic emission structure, the slim enclosure speaker comprising:
a microspeaker;
a lower case enclosing the lower side of the microspeaker and defining a resonance space;
an upper case having a fixing surface to which top edges of the microspeaker are fixed, defining the resonance space together with the lower case, and having a hole inside the fixing surface;
a cover coupled onto the upper case and covering the hole; and
an acoustic passage defined by one side of the upper case and the cover,
wherein the fixing surface is insert injection-molded using a steel.

2. The slim enclosure speaker of claim 1, wherein a central portion of the lower case and a central portion of the cover are composed of insert injection-molded steel portions, respectively, which are thinner than injection-molded portions to form stepped portions.

3. The slim enclosure speaker of claim 2, wherein a resonance space is defined between the steel portion of the lower case and the microspeaker.

4. The slim enclosure speaker of claim 1, wherein the microspeaker is bonded to the fixing surface of the upper case.

5. The slim enclosure speaker of claim 1, wherein the upper case is bonded or ultrasonically welded to the lower case, and wherein the upper case is bonded or ultrasonically welded to the cover.

6. The slim enclosure speaker of claim 1, wherein the microspeaker is bonded to the fixing surface of the upper case, wherein the upper case is ultrasonically welded to the lower case, and wherein the cover is bonded to the upper case.
